(19) United States
(12) Patent Application Publication
(10) Pub. No.: US 2024/0219091 A1
(43) Pub. Date: Jul. 4, 2024

(54) Watermaker with Sandwich Evaporation Assembly

(71) Applicants: Kingtronics Smart Industrial Interconnection Networking(Fujian)Co.,Ltd., Xiamen (CN); Kingtronics Smart Industrial (Xiamen) Co.,Ltd., Xiamen (CN)

(72) Inventor: Chee Henry TSENG, Xiamen (CN)

(21) Appl. No.: 18/601,584

(22) Filed: Mar. 11, 2024

(30) Foreign Application Priority Data
Feb. 5, 2024 (CN) 202410167234.9

(51) Int. Cl. F25B 49/02; F25B 40/02; F25B 40/06; F25B 41/20

(52) U.S. Cl. CPC F25B 49/02; F25B 40/02; F25B 40/06; F25B 41/20

(57) ABSTRACT

The present disclosure provides a watermaker with a sandwich evaporation assembly, including: the sandwich evaporation assembly, a compressor, a fan and an expansion valve; the sandwich evaporation assembly is connected to the expansion valve and the compressor; and the fan is arranged on one side of the sandwich evaporation assembly, and when the fan operates, outside air enters the sandwich evaporation assembly to be condensed for making water, and dry air is then blown out from the fan. A structure design of the sandwich evaporation assembly improves water making efficiency of an atmospheric water generator and increases an energy utilization rate of the atmospheric water generator.

### CROSS-REFERENCE TO RELATED APPLICATIONS

This application claims the benefit of priority from Chinese patent application No. 202410167234.9, filed on Feb. 5, 2024. The content of the aforementioned application, including any intervening amendments thereto, is incorporated herein by reference in its entirety.

### TECHNICAL FIELD

The present disclosure relates to the technical field of atmospheric water generation, in particular to a watermaker with a sandwich evaporation assembly.

### BACKGROUND

An atmospheric water generator performs a gasification phase change on a liquid refrigerant in a pipe of an evaporator based on a refrigerant compression, condensation, and evaporation refrigeration principle of a compressor, heat is absorbed, water vapor in air is condensed into water, and a water source of the atmospheric water generator is formed by collecting the water.

A cooling capacity of the evaporator of the atmospheric water generator and an ambient temperature determine water making efficiency. If the ambient temperature is high, a temperature difference between the water vapor in the air and a surface of the evaporator is large, and the water vapor is easy to condense into liquid water. If the ambient temperature is low and is similar to or lower than a temperature of the surface of the evaporator, the water vapor in the air is very difficult to condense into the liquid water to be collected, which greatly reduces the water making efficiency, and affects normal use of a user.

At present, in order to solve the problem of the low water making efficiency caused by the low ambient temperature, an independent heating apparatus is generally added at an air inlet to preheat the air, but additional energy consumption is added, or an overall device of the atmospheric water generator is large.

### SUMMARY

The present disclosure aims to solve one of technical problems in the above technology at least to a certain extent. To this end, one objective of the present disclosure is to propose a watermaker with a sandwich evaporation assembly, the watermaker improves water making efficiency of an atmospheric water generator without adding additional energy consumption, a layout of various components of the atmospheric water generator is compact, and device miniaturization is realized.

To achieve the above objective, an embodiment of the present disclosure proposes a watermaker with a sandwich evaporation assembly, including the sandwich evaporation assembly, a compressor, a fan and an expansion valve;
the sandwich evaporation assembly has a preheater, an evaporator and a radiator, the preheater is arranged on a gas inlet side of the evaporator, the radiator is arranged on an air outlet side of the evaporator, the preheater and the radiator are connected through a first conduit, and the radiator and the evaporator are connected through a second conduit;
the expansion valve is arranged on the second conduit;
the compressor is connected to the evaporator through a third conduit and connected to the preheater through a fourth conduit to suck out a low-temperature and low-pressure refrigerant gas from the evaporator, the low-temperature and low-pressure refrigerant gas is compressed to form a high-temperature and high-pressure superheated refrigerant gas, then the superheated refrigerant gas is fed into the preheater, and then forms a supercooled liquid refrigerant after entering the radiator, the liquid refrigerant is adiabatically throttled into a low-pressure liquid refrigerant by the expansion valve, and then the low-pressure liquid refrigerant is fed into the evaporator; and
the fan is arranged on an air outlet side of the radiator, so that after being preheated by the preheater, outside air enters the evaporator to generate water and cold air, and after the cold air cools the radiator, the residual cold air is then blown to a heat generating component of the atmospheric water generator to perform cooling and heat dissipation.

The watermaker with the sandwich evaporation assembly according to the embodiment of the present disclosure is connected to the expansion valve and the compressor through the sandwich evaporation assembly; and the fan is arranged on one side of the sandwich evaporation assembly, and operates to form a negative air pressure, outside air enters the sandwich evaporation assembly to be condensed for making water, and dry air is then blown out from the fan.

The cold air blown out by the fan is blown to the heat generating component inside the atmospheric water generator, making full use of the residual cold air for heat dissipation.

The sandwich evaporation assembly includes: the evaporator, the preheater and the radiator, the preheater is arranged on one side of a gas inlet of the evaporator, and the radiator is arranged on one side of an air outlet of the evaporator to form a sandwich-like structure; and the preheater and the radiator constitute a refrigerant condenser through a series connection or a parallel connection of a refrigerant pipeline, and the water making efficiency may be improved regardless of whether an ambient temperature is high or low.

In an atmospheric water generation process, the high-temperature and high-pressure refrigerant gas (with a temperature of about 50° C.-80° C.) output by the compressor forms a refrigerant liquid after being cooled by the preheater and the radiator, the refrigerant liquid is subjected to a gasification phase change in a pipe of the evaporator after passing through the expansion valve, outside heat is absorbed, a formed refrigerant low-pressure gas is then fed back to the compressor, and so the refrigerant is treated circularly.

At the same time, in the atmospheric water generation process, the outside air first passes through the preheater in the sandwich evaporation assembly, the air is preheated to increase a temperature of the air, the preheated air enters the evaporator, and a water vapor in the air is condensed into liquid water; and a temperature difference between the preheated air and a surface of the evaporator is increased, which improves efficiency of condensing the water vapor into the liquid water.

The high-temperature and high-pressure refrigerant gas preheats the air flowing through the preheater after entering the preheater, at the same time, the air also cools the refrigerant gas in the preheater, thereby making full use of the high-temperature and high-pressure refrigerant gas as a high-temperature energy source of the preheater to preheat the air passing through the preheater, and at the same time, the refrigerant may also be cooled without adding additional energy consumption.

In addition, the dry cold air formed after the air passes through the evaporator is blown to the radiator to dissipate heat for the radiator, so that the refrigerant gas inside the radiator is further cooled and thus fully liquefied; and making full use of the cold air to dissipate the heat greatly improves effects of heat dissipation and liquefaction of the refrigerant, thus improving refrigeration efficiency and a refrigeration capacity of the refrigerant, and meanwhile improving energy utilization efficiency.

In summary, the watermaker improves the water making efficiency of the atmospheric water generator without adding the additional energy consumption, the layout of various components of the atmospheric water generator is compact, and device miniaturization is realized.

Additional aspects and advantages of the present disclosure will be partly given in the following description, and will partly become apparent from the following description, or be learned through the practice of the present disclosure.

### BRIEF DESCRIPTION OF FIGURES

FIG. 1 is a schematic diagram of a water making process of a watermaker with a sandwich evaporation assembly according to an embodiment of the present disclosure.

FIG. 2 is a schematic diagram of a connection of a refrigerant pipeline of a watermaker with a sandwich evaporation assembly according to an embodiment of the present disclosure.

FIG. 3 is a schematic diagram of a sandwich evaporation assembly according to an embodiment of the present disclosure.

### DESCRIPTION OF REFERENCE NUMERALS

sandwich evaporation assembly 1, evaporator 110, preheater 120, and radiator 130;
compressor 2;
fan 3;
expansion valve 4; and
first conduit 510, second conduit 520, third conduit 530, and fourth conduit 540.

### DETAILED DESCRIPTION

Embodiments of the present disclosure are described in detail below, and examples of the embodiments are shown in accompanying drawings, where the same or similar reference numerals indicate the same or similar elements or elements having the same or similar functions throughout. The embodiments described below with reference to the accompanying drawings are exemplary, and are intended to explain the present disclosure and cannot be construed as a limitation to the present disclosure.

For a better understanding of the above technical scheme, the exemplary embodiments of the present disclosure will be described in more detail below with reference to the accompanying drawings. Although the exemplary embodiments of the present disclosure are shown in the accompanying drawings, it should be understood that the present disclosure may be implemented in various forms but should not be limited to the embodiments set forth herein. Rather, these embodiments are provided so that the present disclosure can be understood more thoroughly, and the scope of the present disclosure can be fully conveyed to those skilled in the art.

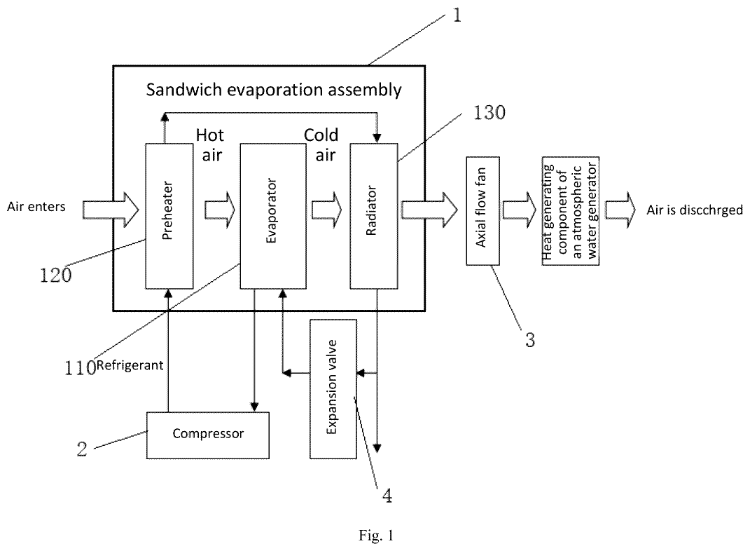

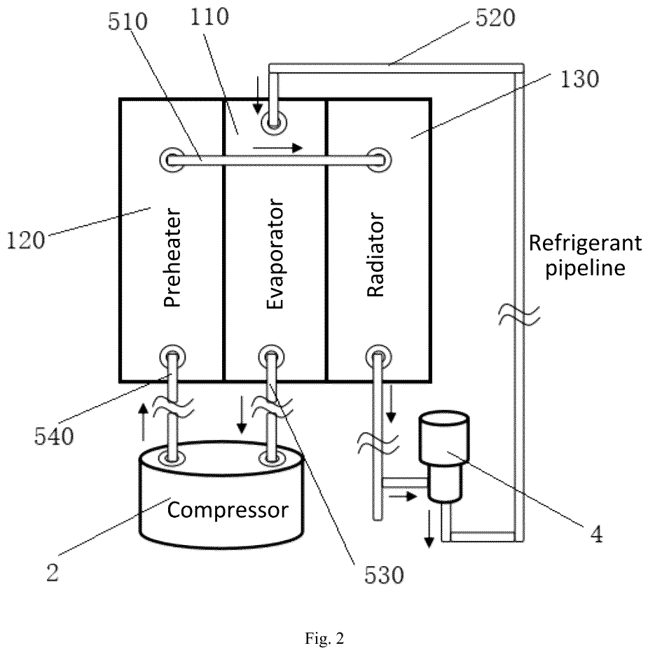

A watermaker with a sandwich evaporation assembly provided by the present disclosure is described in detail below in conjunction with FIG. 1 to FIG. 3.

First, referring to FIG. 1, the watermaker with the sandwich evaporation assembly according to an embodiment of the present disclosure includes the sandwich evaporation assembly 1, a compressor 2, a fan 3 and an expansion valve 4.

Specifically, the sandwich evaporation assembly 1 is connected to the expansion valve 4 and the compressor 3; and the fan 3 is arranged on one side of the sandwich evaporation assembly 1, and operates to form a negative air pressure, outside air enters the sandwich evaporation assembly 1 to be condensed for making water, and dry air is then blown out from the fan 3.

The sandwich evaporation assembly 1 includes: an evaporator 110, a preheater 120 and a radiator 130, the preheater 120 is arranged on a gas inlet side of the evaporator 110, and the radiator 130 is arranged on an air outlet side of the evaporator 110 to form a sandwich-like structure; and the preheater 120 and the radiator 130 are connected through a first conduit 510, the radiator 130 and the evaporator 110 are connected through a second conduit 520, so that the preheater 120 and the radiator 130 constitute a refrigerant condenser through a series connection or a parallel connection of a refrigerant pipeline, and the expansion valve 4 is arranged on the second conduit 520 to feed a condensed refrigerant into the evaporator 110.

The compressor 2 is connected to the evaporator 110 through a third conduit 530 and connected to the preheater 120 through a fourth conduit 540 to suck out a low-temperature and low-pressure refrigerant gas from the evaporator 110, the low-temperature and low-pressure refrigerant gas is compressed to form a high-temperature and high-pressure superheated refrigerant gas, then the superheated refrigerant gas is fed into the preheater 120, and then forms a supercooled liquid refrigerant after entering the radiator 130, the liquid refrigerant is adiabatically throttled into a low-pressure liquid refrigerant by the expansion valve 4, and then the low-pressure liquid refrigerant is fed into the evaporator 110.

In this way, in an atmospheric water generation process, the high-temperature and high-pressure refrigerant gas (with a temperature of about 50° C.-80° C.) output by the compressor 2 forms a refrigerant liquid after being cooled by the preheater 120 and the radiator 130, the refrigerant liquid is subjected to a gasification phase change in a pipe of the evaporator 110 after passing through the expansion valve 4, outside heat is absorbed, a formed refrigerant low-pressure gas is then fed back to the compressor 2, and so the refrigerant is treated circularly.

In addition, the fan 3 is arranged on an air outlet side of the radiator 130, so that after being preheated by the preheater 120, the outside air enters the evaporator 110 to generate water and cold air, and after the cold air cools the radiator 130, the residual cold air is then blown to a heat generating component of an atmospheric water generator to perform cooling and heat dissipation.

In other words, in the atmospheric water generation process, the outside air first passes through the preheater 120 in the sandwich evaporation assembly 1, and the air is preheated to increase a temperature of the air; the preheated air passes through the evaporator 110, and a water vapor in the air is condensed into liquid water; and a temperature difference between the preheated air and a surface of the evaporator 110 is increased, which improves efficiency of condensing the water vapor into the liquid water. In the process, the high-temperature and high-pressure refrigerant gas preheats the air flowing through the preheater 120 after entering the preheater 120, at the same time, the air also cools the refrigerant gas in the preheater 120, thereby making full use of the high-temperature and high-pressure refrigerant gas as a high-temperature energy source of the preheater 120 to preheat the air passing through the preheater 120, and at the same time, the refrigerant may also be cooled without adding additional energy consumption.

Then, the dry cold air formed after the air passes through the evaporator 110 is blown to the radiator 130 to dissipate heat for the radiator 130, and the refrigerant gas inside the radiator 130 is further cooled and fully liquefied; and making full use of the cold air to dissipate the heat greatly improves effects of heat dissipation and liquefaction of the refrigerant, thus improving refrigeration efficiency and a refrigeration capacity of the refrigerant, and meanwhile improving energy utilization efficiency.

The air blown out by the fan 3 is blown to the heat generating component, such as a controller, inside the atmospheric water generator, so that residual air cold may be fully used for heat dissipation. More specifically, the fan 3 is an axial flow fan, and an air outlet of the axial flow fan faces the compressor 2 and the heat generating component of the atmospheric water generator, so that the energy utilization rate can be increased.

Further, the preheater 120 is provided with a refrigerant coil, cooling fins increasing a heat dissipation contact area are arranged on an outer surface of the refrigerant coil, the high-temperature and high-pressure refrigerant gas (with a temperature of about 50° C.-80° C.) preheats the air flowing through the preheater 120 through the refrigerant coil, and the refrigerant inside the preheater 120 is also cooled at the same time.

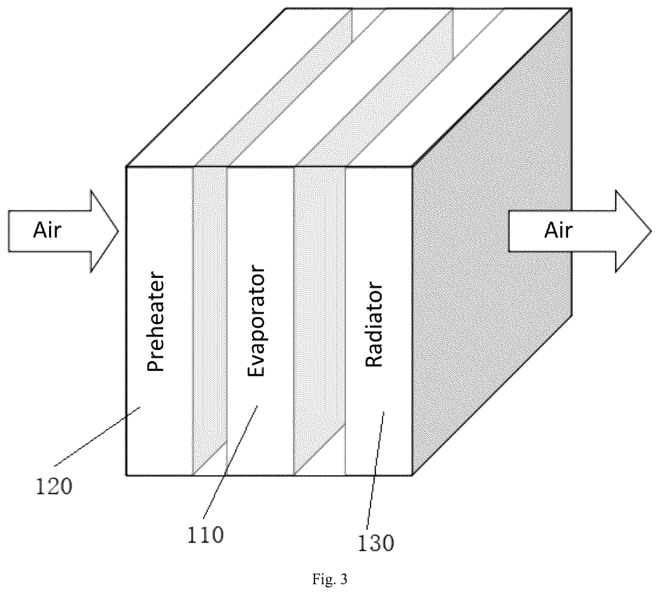

In conjunction with FIG. 3, an existing heat exchanger structure may be adopted for the evaporator 110, the preheater 120 and the radiator 130 in the sandwich evaporation assembly 1.

Thus, compared with a watermaker in the related art, the present embodiment makes full use of the high-temperature and high-pressure refrigerant gas as the high-temperature energy source of the preheater 120 to preheat the air passing through the preheater 120, while the refrigerant may also be cooled without adding additional energy consumption. The temperature difference between the preheated air and the surface of the evaporator 110 is increased, which improves the efficiency of condensing the water vapor into the liquid water; and the cold air generated in the water making process of the evaporator 110 is fully used to dissipate the heat for the refrigerant in the radiator 130, thus improving the refrigeration efficiency and the refrigeration capacity of the refrigerant, and meanwhile improving the energy utilization efficiency. The preheater 120 and the radiator 130 constitute the refrigerant condenser through the series connection or the parallel connection of the refrigerant pipeline, the evaporator 110 is arranged between the preheater 120 and the radiator 130 to form the evaporation assembly of the sandwich-like structure, and the water making efficiency can be improved regardless of whether the ambient temperature is high or low. Therefore, the watermaker improves the water making efficiency of the atmospheric water generator without adding the additional energy consumption, the layout of various components of the atmospheric water generator is compact, and device miniaturization is realized.

In the description of the present disclosure, it should be understood that orientations or position relationships indicated by terms such as “center”, “longitudinal”, “transverse”, “length”, “width”, “thickness”, “upper”, “lower”, “front”, “back”, “left”, “right”, “vertical”, “horizontal”, “top”, “bottom”, “inside”, “outside”, “clockwise”, and “anticlockwise” are orientations or position relationships shown on the basis of the accompanying drawings, and are used only for facilitating the description of the present disclosure and for simplifying the description, rather than indicating or implying that a mentioned apparatus or component must have a particular orientation or must be constructed and operated in a particular orientation, thus cannot be understood as a limitation to the present disclosure.

In addition, terms “first” and “second” are used only for the purpose of description, and cannot be construed as indicating or implying relative importance or implicitly specifying the quantity of indicated technical features. Thus, the features limited to “first” and “second” mayexplicitly or implicitly include one or more of these features. In the description of the present disclosure, “a plurality of” means two or more, unless otherwise expressly and specifically limited.

In the present disclosure, unless otherwise expressly specified and limited, terms “mounted”, “connected”, “connection”, “fixed”, etc. are to be understood in a broad sense, for example, as a fixed connection, as a detachable connection, or as an integral part; as a mechanical connection, or as an electrical connection; and as a direct connection, as an indirect connection through an intermediate medium, as communication within two elements or as an interactive relationship between two elements. Those ordinarily skilled in the art may understand the specific meanings of the above terms in the present disclosure according to specific circumstances.

In the present disclosure, unless otherwise expressly specified and limited, a first feature being “above” or “below” a second feature may include the first and second features being in direct contact, or may include the first and second features not being in direct contact, but being in contact through another feature between them. In addition, the first feature being “above”, “over”, and “on” the second feature includes that the first feature is directly above and obliquely above the second feature, or may only indicate that the horizontal height of the first feature is larger than that of the second feature. The first feature being “below”, “under”, and “beneath” the second feature includes that the first feature is right below and obliquely below the second feature, or may only indicate that the horizontal height of the first feature is smaller than that of the second feature.

In the descriptions of this specification, descriptions referring to terms such as “an embodiment”, “some embodiments”, “an example”, “a specific example”, or “some examples” means that a specific feature, structure, material, or characteristic that is described with reference to the embodiment or the example is contained in at least one embodiment or example of the present disclosure. In this specification, schematic representations of the foregoing terms should not be understood as being necessarily directed at the same embodiment or example. Moreover, the described specific feature, structure, material, or characteristic may be combined in any one or more embodiments or examples in a suitable mode. In addition, those skilled in the art may integrate and combine different embodiments or examples described in this specification.

Although the embodiments of the present disclosure have been shown and described above, it may be understood that the foregoing embodiments are exemplary and should not be understood as limitation to the present disclosure. Those ordinarily skilled in the art may make changes, modifications, substitutions, and variations to the foregoing embodiments within the scope of the present disclosure.

What is claimed is:

1. A watermaker with a sandwich evaporation assembly, comprising the sandwich evaporation assembly, a compressor, a fan and an expansion valve; wherein
the sandwich evaporation assembly has a preheater, an evaporator and a radiator, the preheater is arranged on a gas inlet side of the evaporator, the radiator is arranged on an air outlet side of the evaporator, the preheater and the radiator are connected through a first conduit, and the radiator and the evaporator are connected through a second conduit;
the expansion valve is arranged on the second conduit;
the compressor is connected to the evaporator through a third conduit and connected to the preheater through a fourth conduit to suck out a low-temperature and low-pressure refrigerant gas from the evaporator, the low-temperature and low-pressure refrigerant gas is compressed to form a high-temperature and high-pressure superheated refrigerant gas, then the superheated refrigerant gas is fed into the preheater, and then forms a supercooled liquid refrigerant after entering the radiator, the liquid refrigerant is adiabatically throttled into a low-pressure liquid refrigerant by the expansion valve, and then the low-pressure liquid refrigerant is fed into the evaporator; and
the fan is arranged on an air outlet side of the radiator, so that after being preheated by the preheater, outside air enters the evaporator to generate water and cold air, and after the cold air cools the radiator, the residual cold air is then blown to a heat generating component of an atmospheric water generator to perform cooling and heat dissipation.

2. The watermaker with the sandwich evaporation assembly according to claim 1, wherein a refrigerant coil is arranged in the preheater, and cooling fins are distributed on an outer surface of the refrigerant coil.

3. The watermaker with the sandwich evaporation assembly according to claim 1, wherein the fan is an axial flow fan, and an air outlet of the axial flow fan faces the compressor and the heat generating component of the atmospheric water generator.
